(19) United States
(12) Patent Application Publication
(10) Pub. No.: US 2007/0247507 A1
(43) Pub. Date: Oct. 25, 2007

(54) Trace forming method, droplet ejection apparatus, and circuit module

(75) Inventor: Hirotsuna Miura, Fujimi (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/788,980

(22) Filed: Apr. 23, 2007

(30) Foreign Application Priority Data
Apr. 24, 2006 (JP) 2006119563
Feb. 1, 2007 (JP) 2007023389

(51) Int. Cl. B41J 2/01

(52) U.S. Cl. 347/102

(57) ABSTRACT

A trace forming method comprises ejecting a droplet of a trace forming material onto a substrate; radiating a laser beam on to the droplet on the substrate for drying the droplet to form a trace with the droplet; and using a polarized light with 80% to 100% of p-polarized components as the laser beam.

### CROSS-REFERENCE TO RELATED APPLICATIONS

This application is based upon and claims the benefit of priority from prior Japanese Patent Application No. 2006-119563, filed on Apr. 24, 2006 and Japanese Patent Application No. 2007-023389, filed on Feb. 1, 2007, the entire contents of which are incorporated herein by reference.

### FIELD OF THE INVENTION

The present invention relates to a trace forming method, a droplet ejection apparatus, and a circuit module.

### BACKGROUND

As a circuit module in which electronic components such as semiconductor devices are mounted, a type including low temperature co-fired ceramic (LTCC) multilevel substrate formed of glass ceramic is known. The LTCC multilevel substrate includes stacked green sheets that can be co-fired at a low temperature, or a temperature not higher than 90° C. This allows use of low melting metal such as silver or gold for forming internal traces, which lowers the resistance of the internal traces.

To manufacture an LTCC multilevel substrate, a trace pattern is formed on each of the green sheets using metal paste or metal ink before stacking the green sheets together. As a method for forming the trace pattern, Japanese Laid-Open Patent Publication No. 2005-57139 proposes an inkjet method in which microdroplets of metal ink are ejected. The inkjet method involves joining the microdroplets, or dots, together to provide the trace pattern. The method is thus quickly responsive to increased density of internal traces and decreased trace widths or pitches.

After the droplets, or the dots, are received by the green sheets, the sizes and the shapes of the droplets change as the time elapses depending on the surface condition of the green sheets or the surface tension acting in the droplets. The droplets, the sizes and the shapes of which change, regulate the size of the conducting trace as a whole in correspondence with timings at which the droplets are dried. For example, if a droplet of metal ink having an outer diameter of 30 μm is ejected onto a lyophilic green sheet, the droplet enlarges to an outer diameter of 70 μm after 100 milliseconds and an outer diameter of 100 μm after 200 milliseconds. Therefore, if the timings at which the droplets are dried vary in the range of 100 milliseconds to 200 milliseconds, the sizes of the resulting dots vary. In other words, the width of the corresponding conducting trace varies in the range of approximately 70 μm to 100 μm.

As a droplet drying method that suppresses size variation of dots, laser drying in which a laser beam is radiated onto a droplet on a green sheet has been proposed. By the laser drying, droplets only in a laser radiation area are dried. This improves accuracy for controlling timings at which droplets are dried on green sheets, suppressing the size variation of the dots.

However, in a droplet ejection apparatus used for the inkjet method, the interval between a droplet ejection head and a target is as small as several hundreds of micrometers to ensure a sufficient accuracy of reception of droplets by the target. Therefore, to dry a droplet located immediately below the droplet ejection head immediately after the droplet has been received by the target, a laser beam must be radiated through the narrow gap between the droplet ejection head and the target substantially along a tangential direction of the target. This increases the optical cross-sectional area (the beam spot) of the laser beam on the target, making it impossible to ensure sufficient intensity of the laser beam for drying the droplet. The droplet thus may not be sufficiently dried, causing defects in formation of traces by dots.

### SUMMARY

Accordingly, it is an objective of the present invention to provide a trace forming method, a droplet ejection apparatus, and a circuit module that improve efficiency for drying droplets and suppress defects in formation of traces by dots.

According to a first aspect of the invention, a trace forming method is provided. The method includes: ejecting a droplet of a trace forming material onto a substrate; radiating a laser beam on to the droplet on the substrate for drying the droplet to form a trace with the droplet; and using a polarized light with 80% to 100% of p-polarized components as the laser beam.

According to a second aspect of the invention, a droplet ejection apparatus is provided. The apparatus includes a droplet ejection head ejecting a droplet of a trace forming material onto a substrate, and a laser radiation device that radiates a laser beam onto the droplet on the substrate. The laser beam is a polarized light with 80% to 100% of p-polarized components.

According to a third aspect of the invention, a circuit module having a substrate, a circuit element formed on the substrate, and a metal trace is provided. The metal trace is provided on the substrate and electrically connected to the circuit element. The metal trace is formed using a droplet ejection apparatus. The apparatus includes a droplet ejection head that ejects a droplet of a trace forming material, and a laser radiation device that radiates a laser beam onto the droplet on the substrate. The laser beam is a polarized light with 80% to 100% of p-polarized components.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing a circuit module according to the present invention;

FIG. 2 is a view for explaining a method for manufacturing the circuit module of FIG. 1;

FIG. 3 is a perspective view showing a droplet ejection apparatus;

FIG. 4 is a perspective view showing a droplet ejection head;

FIG. 5 is a cross-sectional view showing the droplet ejection head taken along line A-A of FIG. 4;

FIG. 6 is a view schematically showing a semiconductor laser; and

FIG. 7 is an electric block diagram representing the electric configuration of the droplet ejection apparatus.

### DESCRIPTION OF EXEMPLARY EMBODIMENTS

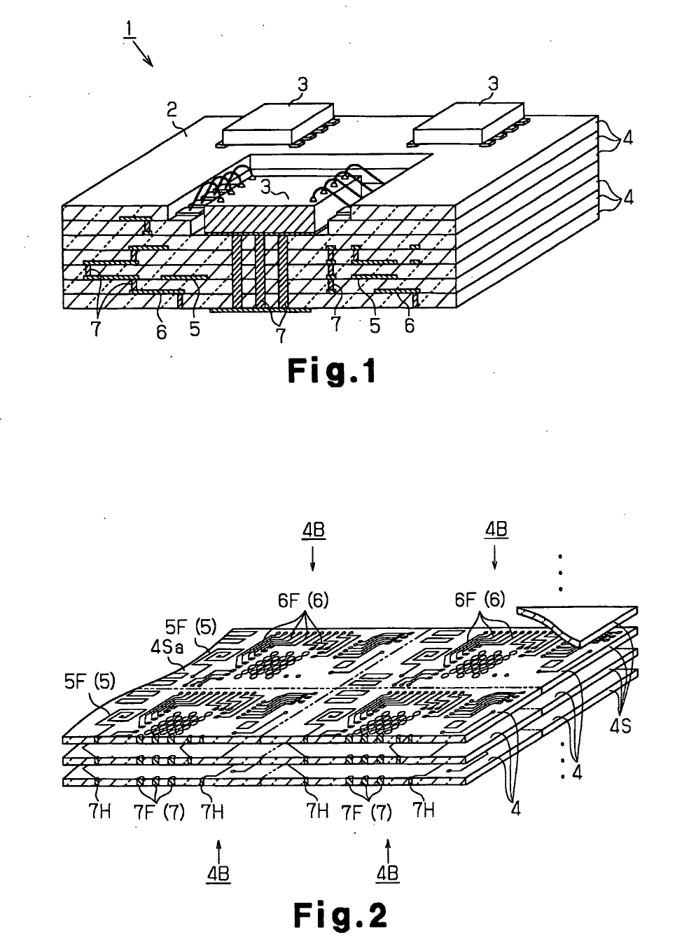

An embodiment of the present invention will now be described with reference to FIGS. 1 to 7. First, a circuit module 1 of the present invention will be explained.

In the following description, directions +X, +Y, +Z are indicated by corresponding arrows in drawings. The negative directions −X, −Y, −Z are the directions opposite to directions +X, +Y, +Z, respectively. The plainly expressed directions X, Y, Z correspond to directions ±X, ±Y, ±Z, respectively.

As shown in FIG. 1, the circuit module 1 includes a plate-like LTCC multilevel substrate 2 and a plurality of semiconductor chips 3, which are provided on the LTTC multilevel substrate 2 and connected together through wire bonding or flip chip bonding.

The LTCC multilevel substrate 2 has a plurality of sheet-like low temperature co-fired ceramic substrates (hereinafter, referred to simply as insulating layers 4), which are stacked together. Each of the insulating layers 4 is a baked body of glass ceramic material and the thickness of the insulating layer 4 is several hundreds of micrometers. The glass ceramic material is, for example, a mixture of a glass element such as alkali oxide of borosilicic acid and a ceramic element such as alumina.

Various types of circuit elements 5 such as a resistance element, a capacity element, a coil element, and a plurality of internal traces 6, or metal traces electrically connecting the circuit elements 5 together, are provided between each adjacent pair of the insulating layers 4. The circuit elements 5 and the internal traces 6 are baked bodies of metal particles such as silver or silver alloy particles and formed using a droplet ejection apparatus 10 of the present invention. Via traces 7 having a stacked via structure or a thermal via structure are formed in each of the insulating layers 4. The via traces 7 electrically connect the circuit elements 5 and the internal traces 6 together throughout the insulating layers 4. Each of the via traces 7 is a baked body of metal particles such as silver or silver alloy particles, like the circuit elements 5 and the internal traces 6.

A method for manufacturing the above-described LTCC multilevel substrate 2 will hereafter be explained with reference to FIG. 2.

Referring to FIG. 2, green sheets 4S are substrates that are cut apart to provide the insulating layers 4. Via holes 7H are defined in each of the green sheets 4S through punching or laser machining. Each green sheet 4S is then subjected to a plurality of cycles of screen printing using metal paste in such a manner as to fill the via holes 7H with the metal paste, forming via traces 7F of the metal paste. Subsequently, inkjet printing is performed on the top surface of each green sheet 4S, or a trace forming surface 4Sa, using metal ink F. The metal ink F is material prepared by dispersing metal nano-particles in water-based solvent for forming dots, or a trace. The metal ink F is, in the illustrated embodiment, water-based silver ink.

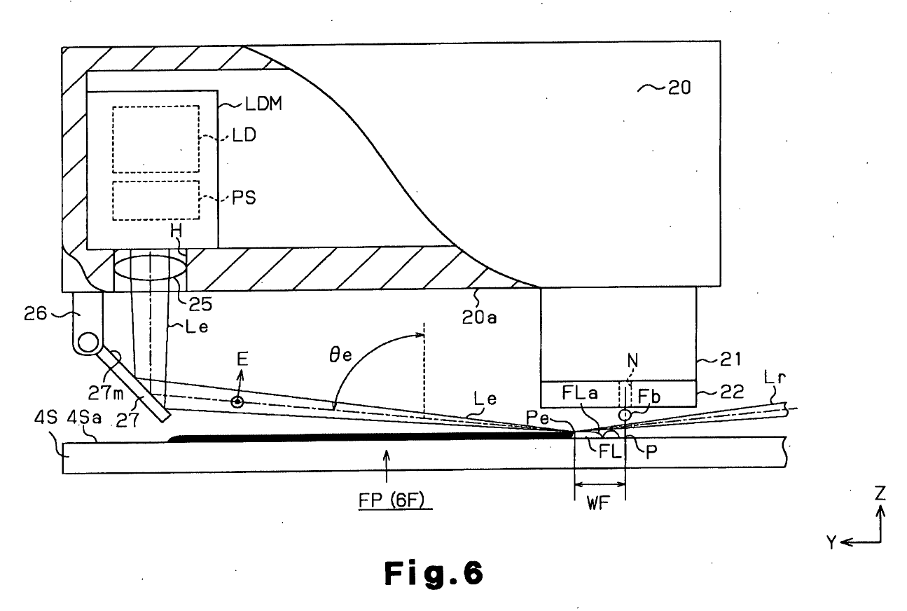

Specifically, droplets Fb of the metal ink F are ejected onto an area (hereinafter, referred to simply as a trace forming area) on the trace forming surface 4Sa in which the circuit elements 5 and the internal traces 6 are to be provided. The droplets Fb are then dried in the trace forming area. Such ejection and drying are repeated to form a corresponding element trace 5F and a corresponding conducting trace 6F in the trace forming area. The droplets Fb received in the trace forming area are dried by radiating incident light Le (see FIG. 6) onto an area in which the droplets Fb have been received and joined together.

After forming the element traces 5F, the conducting traces 6F, and the via traces 7F in the green sheets 4S, the green sheets 4S are stacked altogether. Then, the portions corresponding to the LTCC multilevel substrates 2 are cut out and baked as a stacked body 4B. In other words, the green sheets 4S, the element traces 5F, the traces 6F, and the via traces 7F are stacked altogether and baked simultaneously. In this manner, the LTTC substrates 2 each having the insulating layers 4, the circuit elements 5, the internal traces 6, and the via traces 7 are obtained.

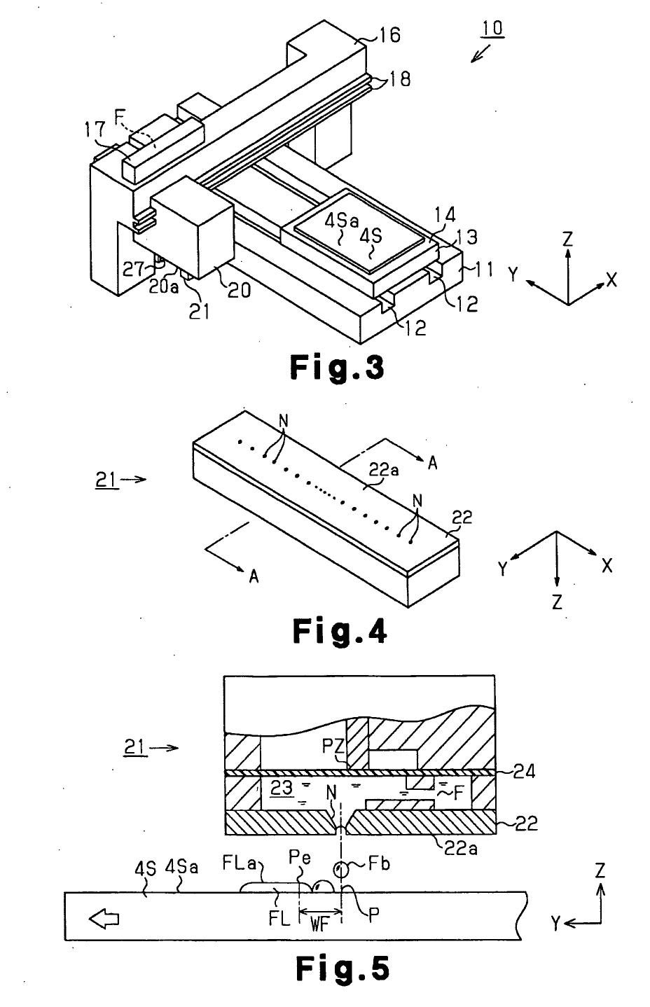

With reference to FIG. 3, the droplet ejection apparatus 10 by which the element traces 5F and the conducting traces 6F are formed will be explained. FIG. 3 is a perspective view showing the droplet ejection apparatus 10 as a whole.

As shown in FIG. 3, the droplet ejection apparatus 10 has a base 11 shaped as a rectangular parallelepiped. A pair of guide grooves 12 are defined in the top surface of the base 11, extending in the longitudinal direction of the base 11 (in the directions ±Y). A stage 13 is provided above the guide grooves 12 and moves in the directions ±Y along the guide grooves 12. A mounting portion 14 is formed on the top surface of the stage 13 and the green sheet 4S is mounted on the mounting portion 14 with the trace forming surface 4Sa facing upward. The mounting portion 14 fixes the mounted green sheet 4S to the stage 13 and transports the green sheet 4S in the directions ±Y. In the illustrated embodiment, direction ±Y in FIG. 3 is defined as a scanning direction.

A gate-like guide member 16 projects from opposing sides of the base 11 in direction X perpendicular to the scanning direction in such a manner as to straddle the base 11. An ink tank 17, which extends in direction X, is arranged on the guide member 16. The ink tank 17 retains the metal ink F and supplies the metal ink F to a droplet ejection head 21, which is provided below the ink tank 17, under a predetermined level of pressure.

A pair of upper and lower guide rails 18 extending in direction X are formed substantially along the entire width of the guide member 16 in direction X and located in direction −Y with respect to the guide member 16. A carriage 20 is secured to the guide rails 18 and moves along the guide rails 18 and in the directions ±Y. An ejection head 21 is arranged at a bottom surface 20a of the carriage 20. FIG. 4 is a perspective view showing the ejection head 21 as viewed from below (from the side corresponding to the green sheet 4S). FIG. 5 is a cross-sectional view showing the droplet ejection head taken along line A-A of FIG. 4. FIG. 6 is a side view schematically showing the carriage 20.

As shown in FIG. 4, the ejection head 21 is shaped as a rectangular parallelepiped extending in direction X. A nozzle plate 22 is provided in a lower portion of the ejection head 21 (the green sheet 4S is located in an upper portion of FIG. 4). The nozzle plate 22 is shaped as a plate extending in direction X and a nozzle forming surface 22a is formed in the lower surface (the upper surface as viewed in FIG. 4) of the nozzle plate 22. The nozzle forming surface 22a extends substantially parallel with the trace forming surface 4Sa of the green sheet 4S. When the green sheet 4S is located immediately below the ejection head 21, the distance (a platen gap) between the nozzle forming surface 22a and the trace forming surface 4Sa is maintained at a predetermined level, which is, in the illustrated embodiment, 300 μm. A plurality of nozzles N are defined in the nozzle forming surface 22a and aligned along direction X. Each of the nozzles N extends through the nozzle forming surface 22a in a normal direction of the nozzle forming surface 22a.

Referring to FIG. 5, cavities 23 are defined above the nozzles N and communicate with the ink tank 17. Each of the cavities 23 supplies the metal ink F from the ink tank 17 to the corresponding one of the nozzles N. An oscillation plate 24 is bonded with an upper wall of each cavity 23. Each of the oscillation plates 24 is capable of oscillating in an up-and-down direction and increases and decreases the volume of the corresponding one of the cavities 23. A plurality of piezoelectric elements PZ are provided on the oscillation plates 24 in correspondence with the nozzles N. Each of the piezoelectric elements PZ oscillates the associated one of the oscillation plates 24 in the up-and-down direction, causing ejection of the metal ink F from the corresponding one of the nozzles N as a predetermined volume (in the illustrated embodiment, 10 pl) of droplet Fb. The droplet Fb then travels in direction −Z and reaches a position on the trace forming surface 4Sa opposed to the nozzle N. While moving in a scanning direction, the droplet Fb spreads wet on the trace forming surface 4Sa and joins with a precedingly ejected droplet Fb. The joined droplets Fb form a liquid film FL extending in the scanning direction when the green sheet 4S is moved in the scanning direction. The liquid film FL forms a liquid surface FLa, which extends parallel with the trace forming surface 4Sa, on the entire top surface of the liquid film FL.

In the illustrated embodiment, a position located on the trace forming surface 4Sa in correspondence with each of the nozzles N in direction −Z, or a position at which a droplet Fb is received by the trace forming surface 4Sa, is defined as a droplet receiving position P. An end of the liquid surface FLa located in the direction opposite to the scanning direction, or in direction −Y, is defined as an incident position Pe. The distance between the droplet receiving position P and the incident position Pe is defined as a standby distance WF.

Referring to FIG. 6, a light exit hole H is defined in a bottom surface 20a of the carriage 20 and extends into the interior of the carriage 20 in the scanning direction of the ejection head 21, or direction +Y. The width of the light exit hole H in direction X is substantially equal to the width of the ejection head 21 in direction X. A semiconductor laser module LDM, which forms a laser radiation device, is provided above the light exit hole H of the carriage 20.

The semiconductor module LDM includes a semiconductor laser LD and an optical element PS forming an optical radiation system. The semiconductor laser LD radiates a belt-like collimated laser beam, which spreads substantially along the entire width of the light exit hole H in direction X, downward. The wavelength of the laser beam radiated by the semiconductor laser LD is set in the range of the absorption wavelength of the metal ink F (in the illustrated embodiment, 808 nm). The optical element PS includes a retarder. The optical element PS converts the polarized state of the laser beam from the semiconductor laser LD to a prescribed state of linearly polarized light, which is, in the illustrated embodiment, to the state of a polarized light with 100% of p-polarized light components. The optical element PS then radiates the polarized light downward.

A cylindrical lens 25 forming the optical radiation system is arranged in the light exit hole H. The lens 25 is a lens having curvature only in direction Y. The width of the lens 25 in direction X is equal to the width of the ejection head 21 in direction X. After receiving the laser beam from the semiconductor laser module LDM, the lens 25 converges only components of the laser beam in direction +Y (or direction −Y) and radiates the elements downwardly as incident light Le.

A mirror stage 26 extending downward from the carriage 20 and a reflective mirror 27 pivotally supported by the mirror stage 26 are provided below the light exit hole H. The reflective mirror 27 forms the optical radiation system. The mirror stage 26 supports the reflective mirror 27 pivotally about a pivotal axis extending along direction X. The reflective mirror 27 is a galvanic mirror and has a reflective surface 27m located at the side facing the cylindrical lens 25. The width of the mirror 27 in direction X is equal to the width of the ejection head 21 in direction X. The reflective mirror 27 receives the incident light Le from the lens 25 by the reflective surface 27m and reflects the incident light Le substantially along the tangential direction of the trace forming surface 4Sa. In the illustrated embodiment, the angle between a normal line of the liquid surface FLa (the trace forming surface 4Sa) and the incident light Le that has been reflected is defined as the incident angle θe and set to 88°.

After having been reflected by the reflective mirror 27, the incident light Le is introduced through the gap between the ejection head 21 and the green sheet 4S and the area of the incident light Le corresponding to the beam waist reaches the incident position Pe on the liquid surface FLa. Some of the incident light Le received at the incident position Pe is transmitted through and absorbed by the liquid film FL. Specifically, when the green sheet 4S is moved in the scanning direction, or direction +Y, some of the incident light Le reflected by the reflective mirror 27 sequentially dries the liquid film FL in the vicinity of the incident position Pe. In this manner, a layer trace FP extending in the scanning direction is provided.

Some of the incident light Le that has reached the incident position Pe is not transmitted through the liquid film FL and reflected in the direction opposite to the scanning direction as reflected light Lr. In the illustrated embodiment, a plane (a Y-Z plane) defined by the reflected incident light Le and the reflected light Lr corresponding to the reflected incident light Le is defined as the incident plane.

The reflectance of the incident light Le with respect to the liquid film FL changes in correspondence with the polarized state of the incident light Le. Specifically, the reflectance Rp of the polarized light (the p-polarized light) in which the direction of the electric field vector E is parallel with the incident plane and the reflectance Rs of the polarized light (the S polarized light) in which the direction of the electric field vector E is perpendicular to the incident plane are obtained by the following equations in which N1 represents the refraction factor of the air and N2 represents the refraction factor of the liquid film FL. The reflectance Rp of the p-polarized light is lower than the reflectance Rs of the s-polarized light at a given incident angle θe.

$$Rp = \frac{{\{ N 2 cos θ e - N 1 cos φ \}}^{2}}{{\{ N 2 cos θ e + N 1 cos φ \}}^{2}}$$

$$Rs = \frac{{\{ N 1 cos θ e - N 2 cos φ \}}^{2}}{{\{ N 1 cos θ e + N 2 cos φ \}}^{2}}$$

According to the equations, the following equation is satisfied.

φ=sin⁻¹{(N1/N2)cos(π/2−θe)}

For example, if the refraction factor of the air is 1, the refraction factor of the liquid film FL is 1.3, and the incident angle θe is 88°, the reflectance Rp of the p-polarized light and the reflectance Rs of the s-polarized light are 75.2% and 84.5%, respectively. In other words, the amount of the p-polarized incident light Le transmitted through and absorbed by the liquid film FL after reaching the incident position Pe is approximately 10% greater than the corresponding amount of the incident light Le of the s-polarized light.

In the droplet ejection apparatus 10 of the illustrated embodiment, the optical element PS of the semiconductor laser module LDM converts the laser beam radiated by the semiconductor laser LD to the p-polarized light and radiates the p-polarized incident light Le. In the illustrated embodiment, the p-polarized light is a linearly polarized light with an electric field vector oscillating parallel with the incident plane, which contains substantially no other components, or a polarized light with 100% of p-polarized components.

Therefore, since the polarized state of the incident light Le has been converted into the state of the p-polarized light, a correspondingly great amount of incident light Le is transmitted through and absorbed by the liquid film FL. Such improved absorption rate of the incident light Le allows the incident light Le to reliably dry the liquid film FL, forming the layer trace FP that is sufficiently dry. Then, multiple layer traces FP are sequentially stacked together to form the conducting trace 6F (see FIG. 2), while suppressing defects in formation of the conducting traces 6F.

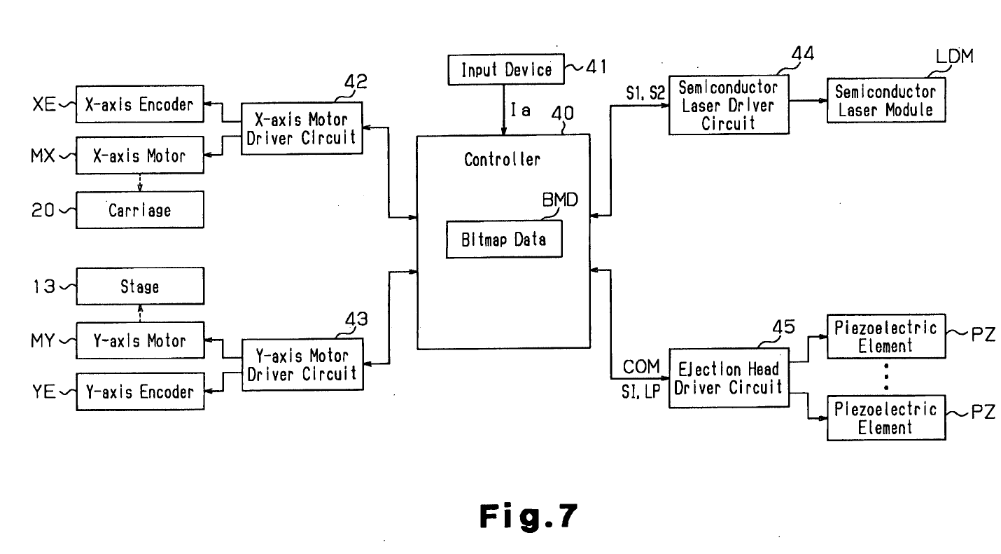

Next, the electric configuration of the droplet ejection apparatus 10, which has the above-described structure, will be described with reference to FIG. 7.

As illustrated in FIG. 7, a controller 40 includes a CPU, a ROM, and a RAM. The controller 40 moves the stage 13 and the carriage 20 and controls operation of the semiconductor laser module LDM and the piezoelectric elements PZ in accordance with various types of stored data and control programs.

An input device 41 having manipulation switches such as a start switch and a stop switch is connected to the controller 40. The input device 41 provides information regarding the position coordinates of the trace forming area (the layer trace FP) with respect to a trace forming plane (the trace forming surface 4Sa) to the controller 40 as a prescribed form of trace forming information Ia. The controller 40 generates bit map data BMD based on the trace forming information Ia sent from the input device 41.

In correspondence with each of the bit values (0 or 1), the bit map data BMD instructs whether to turn on or off the corresponding one of the piezoelectric elements PZ. That is, the bit map data BMD instructs whether to eject a droplet Fb onto each of positions on the trace forming plane (the trace forming surface 4Sa) above which the ejection head 21 is moved. In other words, in accordance with the bit map data BMD, droplets Fb are ejected onto corresponding target positions defined on the trace forming area.

The controller 40 is connected to an X-axis motor driver circuit 42 and provides a corresponding drive signal to the X-axis motor driver circuit 42. In response to the drive signal from the controller 40, the X-axis motor driver circuit 42 rotates an X-axis motor MX in a forward or reverse direction to move the carriage 20. The X-axis motor driver circuit 42 is connected to an X-axis encoder XE and receives a detection signal from the X-axis encoder XE. The X-axis motor driver circuit 42 generates a signal regarding the movement direction and the movement amount of the carriage 20 (each of the droplet receiving positions P) with respect to the trace forming surface 4Sa in correspondence with the detection signal from the X-axis encoder XE. The X-axis motor driver circuit 42 then sends the signal to the controller 40.

The controller 40 is connected to a Y-axis motor driver circuit 43 and provides a corresponding drive signal to the Y-axis motor driver circuit 43. In response to the drive signal from the controller 40, the Y-axis motor driver circuit 43 rotates a Y-axis motor MY in a forward or reverse direction to move the stage 13. The Y-axis motor driver circuit 43 is connected to a Y-axis encoder YE and receives a detection signal from the Y-axis encoder YE. The Y-axis motor driver circuit 43 generates a signal regarding the movement direction and the movement amount of the stage 13 (the trace forming surface 4Sa) in correspondence with the detection signal from the Y-axis encoder YE. The Y-axis motor driver circuit 43 then sends the signal to the controller 40. In correspondence with the signal from the Y-axis motor driver circuit 43, the controller 40 calculates the position of each droplet receiving position P relative to the trace forming surface 4Sa. The controller 40 outputs an ejection timing signal LP each time the droplet receiving positions P reach the corresponding target positions.

The controller 40 is connected to a semiconductor laser driver circuit 44. The controller 40 outputs a trace forming start signal S1 to the semiconductor laser driver circuit 44 to start trace forming and a trace forming end signal S2 to end the trace forming. In response to the trace forming start signal S1, the semiconductor laser driver circuit 44 operates the semiconductor laser module LDM to radiate the p-polarized incident light Le. In response to the trace forming end signal S2, the semiconductor laser driver circuit 44 operates the semiconductor laser module LDM to end radiation of the incident light Le. That is, in trace forming, the controller 40 controls operation of the semiconductor laser module LDM through the semiconductor laser driver circuit 44 to radiate the p-polarized incident light Le.

The controller 40 is connected to an ejection head driver circuit 45 and provides piezoelectric element drive voltage COM for driving the piezoelectric elements PZ to the ejection head driver circuit 45 synchronously with the ejection timing signal LP. Further, in accordance with the bit map data BMD, the controller 40 generates ejection control signals SI synchronized with prescribed clock signals and serially transfers the ejection control signals SI to the ejection head driver circuit 45. The ejection head driver circuit 45 sequentially converts the ejection control signals SI of the controller 40, which are in serial forms, into parallel forms in correspondence with the piezoelectric elements PZ. Further, each time the ejection head driver circuit 45 receives the ejection timing signal LP from the controller 40, the ejection head driver circuit 45 latches the ejection control signals SI, which have been converted into the parallel forms. The ejection head driver circuit 45 then supplies the piezoelectric element drive voltage COM to those of the piezoelectric elements PZ that are selected in accordance with the ejection control signals SI.

Next, a method for forming the element traces 5F and the conducting traces 6F using the droplet ejection apparatus 10 will be explained.

First, as illustrated in FIG. 3, the green sheet 4S is mounted on the stage 13 in such a manner that the trace forming surface 4Sa faces upward. At this stage, the stage 13 arranges the green sheet 4S at a position rearward in the scanning direction of the carriage 20.

In this state, the trace forming information Ia is input to the controller 40 through the input device 41. In accordance with the trace forming information Ia, the controller 40 produces the bit map data BMD and stores the bit map data BMD. Then, the controller 40 operates the X-axis motor driver circuit 42 to arrange the carriage 20 (the ejection head 21) at a predetermined position in such a manner that, when the green sheet 4S is moved, the target positions pass the corresponding droplet receiving positions P. After arranging the carriage 20 at the predetermined position, the controller 40 operates the Y-axis motor driver circuit 43 to start transport of the green sheet 4S.

The controller 40 then outputs the trace forming start signal SI to the semiconductor laser driver circuit 44 and operates the semiconductor laser module LDM to radiate the p-polarized incident light Le. The incident light Le is reflected by the reflective mirror 27 substantially in a tangential direction of the green sheet 4S and reaches the trace forming surface 4Sa at the incident angle θe.

Also, after the transport of the green sheet 4S is started, the controller 40 outputs the ejection control signals SI, which have been generated based on the bit map data BMD, to the ejection head driver circuit 45.

Further, in response to the start of the transport of the green sheet 4S, the controller 40 outputs the ejection timing signal LP to the ejection head driver circuit 45 each time the target positions reach the corresponding droplet receiving positions P. In other words, the controller 40 selects the nozzles N that are to eject the droplets Fb in correspondence with the ejection control signals SI. The controller 40 operates the nozzles N to eject the droplets Fb onto the target positions each time the droplet receiving positions P corresponding to the selected nozzles N reach the target positions.

The ejected droplets Fb reach the corresponding target positions defined on the trace forming surface 4Sa. After having been moved by a standby distance WF, each of the droplets Fb that have reached the target positions is joined with the corresponding one of the precedingly ejected droplets Fb. This forms the liquid film FL, which spreads in the trace forming area. The p-polarized incident light Le is radiated onto the incident position Le on the liquid film FL.

Since the polarized state of the incident light Le that has reached the incident position Pe corresponds to the state of the p-polarized light, the incident light Le is transmitted through and absorbed by the liquid film FL by a correspondingly greater amount. This forms a sufficiently dry layer trace FP. Afterwards, by sequentially stacking layer traces FP together in similar manners, the element trace 5F and the conducting trace 6F are formed. This suppresses defects in formation of the element traces 5F and the conducting traces 6F.

The illustrated embodiment, which is constructed as above-described, has the following advantages.

The semiconductor laser module LDM having the semiconductor laser LD and the optical element PS is mounted in the carriage 20 in which the ejection head 21 is provided. The ejection head 21 forms the liquid film FL through joining of the droplets Fb ejected onto the green sheets 4S. The semiconductor laser module LDM radiates the p-polarized incident light Le onto the liquid surface FLa of the liquid film FL.

Since the polarized state of the incident light Le has been converted into the state of the p-polarized light, the amount of the incident light Le reflected by the liquid surface FLa is decreased and the amount of the incident light Le transmitted through the liquid film FL is increased. This enhances the absorption rate of the incident light Le by the liquid film FL, thus improving efficiency of drying the liquid film FL. In this manner, defects in formation of the element traces 5F and the conducting traces 6F, or the circuit element 5 and the internal traces 6, are suppressed.

The carriage 20 includes the ejection head 21, the semiconductor laser module LDM, and the reflective mirror 27. The position of the incident light Le relative to each of the received droplets Fb is thus maintained. This allows the p-polarized incident light Le to be radiated onto the incident position Pe on the liquid surface FLa with increased reproducibility. The dry states of the element traces 5F and the conducting traces 6F are thus stabilized, further suppressing defects in formation of the circuit elements 5 and the internal traces 6.

Since the light source of the incident light Le is formed by the semiconductor laser LD, the droplet ejection apparatus 10 is reduced in size and weight.

The reflective mirror 27 reflects the incident light Le from the semiconductor laser module LDM substantially along the tangential direction of the green sheet 4S and sends the incident light Le to the liquid surface FLa opposed to the ejection head 21. This allows drying of the droplets Fb immediately after the droplets Fb have been received by the green sheet 4S or joined together. As a result, the shapes and the sizes of the element traces 5F and the conducting traces 6F can be selected from a wider range.

The optical element PS changes the polarized state of the laser beam radiated by the semiconductor laser LD and radiates the p-polarized incident light Le. The laser beam of the p-polarized light is thus constantly received by the liquid surface FLa regardless of the polarized state of the laser beam of the semiconductor laser LD. This further reliably suppresses defects in trace forming.

The illustrated embodiment may be modified in the following forms.

The p-polarized incident light Le may be radiated onto the separate droplets Fb, instead of the liquid film FL in which the droplets Fb are joined together. In other words, as long as the polarized state of the laser beam radiated onto the droplets Fb is the state of the p-polarized light, the present invention is applicable regardless of the shapes of the droplets Fb, which are radiation targets of the laser beams.

The p-polarized incident light Le may be radiated in a direction other than a direction at the incident angle θe, which extends substantially along the tangential direction of the green sheet 4S. For example, the p-polarized incident light Le may be sent at the incident angle θe substantially along a normal direction of the green sheet 4S.

The laser beam radiated by the semiconductor laser LD, or the incident light Le, is not restricted to the polarized light with 100% of p-polarized components but may be a polarized light with at least 80% to 100% of p-polarized components.

Although the liquid film FL is dried by a common incident light Le, the incident light Le from the semiconductor laser module LDM may be divided in correspondence with the nozzles N. Each of the divided rays of the incident light Le is then radiated onto the corresponding portion of the liquid film FL. Alternatively, semiconductor laser modules LDM may be provided by the number equal to the number of the nozzles N. In this case, the incident light Le from each of the semiconductor laser modules LDM is radiated onto the corresponding portion of the liquid film FL.

In these cases, it is preferred that radiation of the incident light Le be performed selectively in correspondence with the ejection control signals SI for selecting the nozzles N. In other words, it is preferred that radiation of the incident light Le be carried out solely in correspondence with the nozzles N that eject the droplets Fb. In this manner, the incident light Le is solely radiated onto the liquid film FL, improving efficiency of using the incident light Le.

The p-polarized incident light Le may not only dry the droplets Fb or the liquid film FL, but also bake the dried droplets Fb or liquid film FL. In this case, the incident light Le, which is locally radiated, suppresses insufficient baking of the element trace 5F and the conducting trace 6F.

Instead of generating the bit map data BMD by the controller 40 in accordance with the trace forming information Ia, the bit map data BMD may be generated in advance by an external device and sent from the input device 41 to the controller 40.

The reflective mirror 27 does not necessarily have to be the galvanic mirror but may be a prism mirror. Alternatively, the reflective mirror 27 may be omitted and the incident light Le may be radiated from the cylindrical lens 25 directly onto the droplets Fb.

The droplet ejection head is not restricted to the droplet ejection head 21, which is a piezoelectric element driven type, but may be an ejection head of a resistance heating type or an electrostatically driven type.

All of the circuit elements 5 and all of the internal traces 6 do not have to be formed by an inkjet method. That is, only comparatively small circuit elements 5 or internal traces 6 may be provided by the inkjet method.

The trace forming material is not restricted to the metal ink but may be a liquid in which insulating film forming material or organic material is dispersed. In other words, the trace forming material may be any suitable material as long as the material is dried by the laser beam and forms traces of solid phase.

The traces are not restricted to the element traces 5F and the conducting traces 6F. The traces may be embodied as various types of metal traces used in liquid crystal displays, organic electroluminescence displays, or electric field effect type displays (FEDs or SEDs) including flat electron release elements. The term traces in this specification, among other types of deposits, include any linear deposits forming a pattern and dots forming an identification code. In other words, traces may be embodied as any suitable form as long as the traces are solid and formed by dried droplets.

The present examples and embodiments are to be considered as illustrative and not restrictive and the invention is not to be limited to the details given herein, but may be modified within the scope and equivalence of the appended claims.

What is claimed is:

1. A trace forming method comprising:
ejecting a droplet of a trace forming material onto a substrate;
radiating a laser beam on to the droplet on the substrate for drying the droplet to form a trace with the droplet; and
using a polarized light with 80% to 100% of p-polarized components as the laser beam.

2. The method according to claim 1, wherein the droplet is dried by radiating the laser beam substantially in a tangential direction of the substrate.

3. A droplet ejection apparatus comprising:
a droplet ejection head ejecting a droplet of a trace forming material onto a substrate; and
a laser radiation device that radiates a laser beam onto the droplet on the substrate,
wherein the laser beam is a polarized light with 80% to 100% of p-polarized components.

4. The apparatus according to claim 3, wherein the laser radiation device radiates the laser beam onto the droplet that faces the droplet ejection head substantially in a tangential direction of the substrate.

5. The apparatus according to claim 3, further comprising a carriage in which the droplet ejection head is mounted, the carriage scanning the droplet ejection head along a certain direction relative to the substrate, wherein the laser radiation device includes:
a semiconductor laser that is mounted in the carriage and radiates the laser beam; and
an optical radiation system that is mounted in the carriage and radiates the laser beam of the semiconductor laser onto the droplet.

6. The apparatus according to claim 5, wherein the optical radiation system includes an optical element that converts a polarized state of the laser beam radiated by the semiconductor laser into a state of the p-polarized light.

7. The apparatus according to claim 3, wherein the trace forming material is a metal ink in which metal particles are dispersed, and
wherein the substrate is a low temperature co-fired ceramic substrate.

8. The apparatus according to claim 3, wherein the droplet ejection head has a nozzle plate including a plurality of nozzles each of which ejects droplets, and
wherein the laser radiation device radiates the laser beam onto each of the droplets on the substrate.

9. The apparatus according to claim 5, wherein the carriage includes a light exit hole through which the laser beam from the semiconductor laser being radiated and
wherein the width of the droplet ejection head in a scanning direction of the droplet ejection head is substantially equal to the width of the light exit hole.

10. A circuit module comprising a substrate, a circuit element formed on the substrate, and a metal trace that is provided on the substrate and electrically connected to the circuit element,
wherein the metal trace is formed using a droplet ejection apparatus, the apparatus including:
a droplet ejection head that ejects a droplet of a trace forming material; and
a laser radiation device that radiates a laser beam onto the droplet on the substrate,
wherein the laser beam is a polarized light with 80% to 100% of p-polarized components.
